(19) United States
(12) Patent Application Publication
(10) Pub. No.: US 2024/0054775 A1
(43) Pub. Date: Feb. 15, 2024

(54) SYSTEM AND METHOD FOR DOMAIN ADAPTIVE OBJECT DETECTION VIA GRADIENT DETACH BASED STACKED COMPLEMENTARY LOSSES

(71) Applicant: CARNEGIE MELLON UNIVERSITY, Pittsburgh, PA (US)

(72) Inventors: Zhiqiang Shen, Pittsburgh, PA (US); Harsh Maheshwari, Pittsburgh, PA (US); Marios Savvides, Pittsburgh, PA (US)

(21) Appl. No.: 18/267,539

(22) PCT Filed: Jan. 31, 2022
(86) PCT No.: PCT/US2022/014485

§ 371 Date: Jun. 15, 2023

Related U.S. Application Data
(60) Provisional application No. 63/147,934, filed on Feb. 10, 2021.

(51) Int. Cl. G06V 10/82; G06V 10/77

(52) U.S. Cl. CPC G06V 10/82; G06V 10/7715

(57) ABSTRACT

Disclosed herein an effective detach strategy which suppresses the flow of gradients from context sub-networks through the detection backbone path to obtain a more discriminative context by forcing the representation of context sub-network to be dissimilar from the detection network. A sub-network is defined to generate the context information from early layers of the detection backbone. Because instance and context focus on perceptually different parts of an image, the representations from either of them should also be discrepant. In addition, a stacked complementary loss is generated to and backpropagated to the detection network.

### RELATED APPLICATIONS

This application claims the benefit of U.S. Provisional Patent Application No. 63/147,934, filed Feb. 10, 2021, the contents of which are incorporated herein in their entirety.

### BACKGROUND

The goal of unsupervised domain adaptive object detection is to learn a robust detector in the domain shift circumstance, where the training (source) domain is label-rich with bounding box annotations, while the testing (target) domain is label-agnostic and the feature distributions between training and testing domains are dissimilar or even totally different.

In real-world scenarios, generic object detection always faces severe challenges from variations in viewpoint, background, object appearance, illumination, occlusion conditions, scene change, etc. These unavoidable factors make object detection in domain-shift circumstance challenging. Also, domain change is a widely-recognized, intractable problem that urgently needs to be addressed for real-world detection tasks, for example, video surveillance, autonomous driving, etc.

Common approaches for addressing domain-shift object detection include: (1) training a supervised model and then fine-tuning the model on the target domain; or (2) unsupervised cross-domain representation learning. The former requires additional instance-level annotations on target data, which is fairly laborious, expensive and time-consuming. As such, most approaches focus on the latter approach, but challenges still remain. The first challenge is that the representations of source and target domain data should be embedded into a common space for matching the object, such as the hidden feature space, input space or both. The second is that a feature alignment/matching operation or mechanism for source/target domains should be further defined, such as subspace alignment, [symbol] -divergence and adversarial learning, MRL, strong-weak alignment, universal alignment, etc.

### SUMMARY

The disclosed invention targets these two challenges and it is also a learning-based alignment method across domains with an end-to-end framework. Disclosed herein is an effective detach strategy which selectively prevents the flow of gradients from context sub-networks through the detection backbone path to obtain a more discriminative context. This path carries information with diversity and, hence, suppressing gradients from this path achieves the desired effect. A sub-network is defined to generate the context information from early layers of the detection backbone. Because instance and context focus on perceptually different parts of an image, the representations from either of them should also be discrepant. However, if the conventional process is used for training, the companion sub-network will be updated jointly with the detection backbone, which may lead to an indistinguishable behavior from these two parts. To this end, the disclosed invention suppresses gradients during backpropagation and forces the representation of context sub-network to be dissimilar from the detection network.

### BRIEF DESCRIPTION OF THE DRAWINGS

By way of example, a specific exemplary embodiment of the disclosed

system and method will now be described, with reference to the accompanying drawings, in which:

FIG. 1 is a block diagram of the stacked complementary loss framework.

FIG. 2 is a meta-language listing of an algorithm for suppressing gradients during backpropagation and forcing the representation of context sub-network to be dissimilar to the detection network.

FIG. 3 is a listing of one exemplary embodiment of an implementation of the context sub-network.

FIG. 4 are illustrations of exemplary source and target domains

### DETAILED DESCRIPTION

Disclosed herein is a design that is specific to convolutional neural network optimization and which improves its training on tasks that adapt on discrepant domains using a novel approach referred to herein as stacked complementary losses (SCL), which is an effective approach for domain-shift object detection. Previous approaches that focus on conducting domain alignment on high-level layers only cannot fully adapt shallow layer parameters to both source and target domains, which restricts the ability of the model to learn. Further, gradient detach is a critical part of learning with complementary losses.

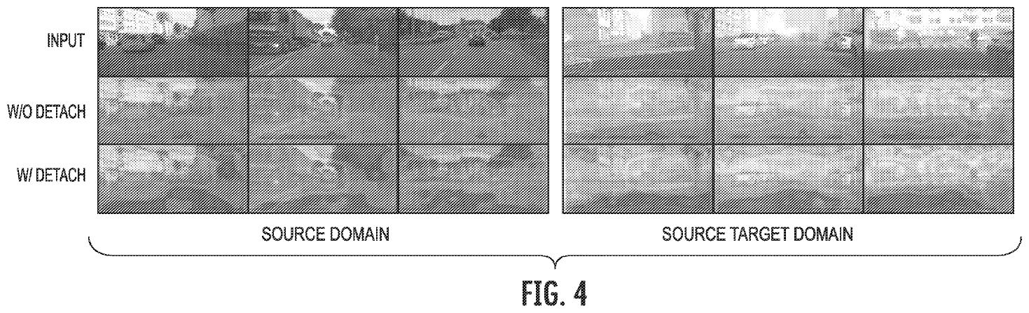

Following the common formulation of domain adaptive object detection, a source domain [symbol] is defined where annotated bounding boxes are available, and a target domain [symbol] where only the image can be used in the training process, without any labels. Examples of a source domain and a target domain are shown in FIG. 4. A robust detector that can adapt well to both source and target domain data is trained (i.e., a domain-invariant feature representation that works well for detection across two different domains is learned).

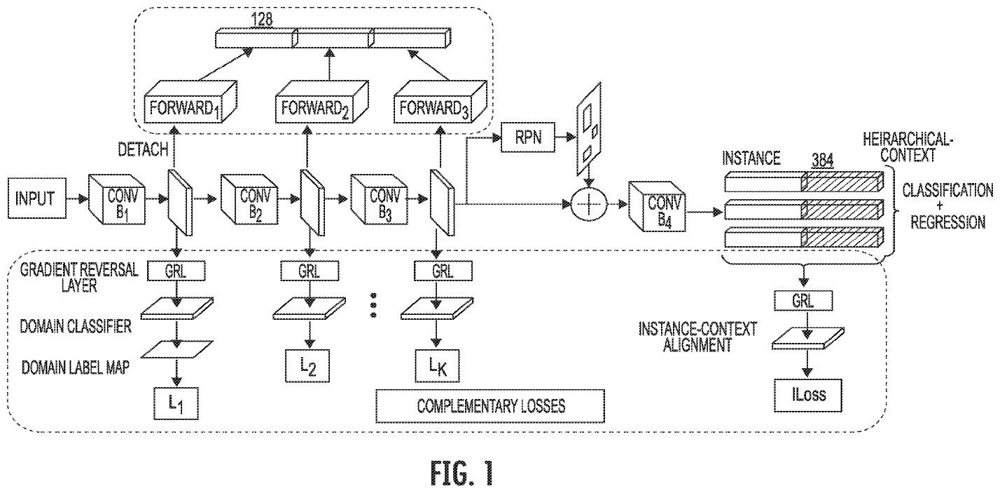

Multi-Complement Objective Learning—FIG. 1 is a block diagram providing an overview of the stacked complementary loss (SCL) framework. As shown in FIG. 1, the framework focuses on complement objective learning and lets [symbol] ={(xᵢ^{(s)},yᵢ^{(s)})}, where xᵢ^{(s)}∈ [symbol] ₙ denotes an image, yᵢ^{(s)} is the corresponding bounding box and category labels for sample xᵢ^{(s)}, and i is an index. Each label y^{(s)}=(y_{c}^{(s)},y_{b}^{(s)}) denotes a class label y_{c}^{(s)} where c is the category, and a 4-dimension bounding-box coordinate y_{b}^{(s)}= [symbol] ⁴. For the target domain only image data is used for training, so [symbol] ={xᵢ^{t}}. A recursive function is defined for layers k=1, 2, . . . , K where complementary losses are cut in:

$${\hat{Θ}}_{k} = ℱ ( {Z}_{k} ) , {Z}_{0} ≡ x \qquad ( 1 )$$

where:
[symbol] is the feature map produced at layer k;
[symbol] is the function to generate features at layer k; and
Zₖ is input at layer k.

The complementary loss of domain classifier k is formulated as follows:

$${ℒ}_{k} ( {\hat{Θ}}_{k}^{( s )} , {\hat{Θ}}_{k}^{( t )} ; {D}_{k} ) = {ℒ}_{k}^{( s )} ( {\hat{Θ}}_{k}^{( s )} ; {D}_{k} ) + {ℒ}_{k}^{( t )} ( {\hat{Θ}}_{k}^{( t )} ; {D}_{k} ) = 𝔼 [ log ( {D}_{k} ( {\hat{Θ}}_{k}^{( s )} ) ) ] + 𝔼 [ log ( 1 - {D}_{k} ( {\hat{Θ}}_{k}^{( t )} ) ) ] \qquad ( 2 )$$

where:
Dₖ is the k th domain classifier or discriminator; and
[symbol] ₖ⁽²⁾ and [symbol] ₖ^{(t)} denote feature maps from the source and target domains respectively.

The framework also adopts a gradient reverse layer (GRL) to enable

adversarial training where a GRL layer is placed between the domain classifier for each layer k and the detection backbone network. During backpropagation, the GRLs reverse the gradient that passes through from the domain classifiers to the detection network. For the instance-context alignment loss [symbol] _{ILoss}, the instance-level

representation and context vector are taken as inputs. The instance-level vectors are from RoI layer that each vector focuses on the representation of local object only. The context vector is from the sub-network that combines hierarchical global features. Instance feature vectors are each concatenated with the same context vector generated by the sub-network. Context information is fairly different from objects, and therefore, when the joint training detection and context networks mix the critical information from each part, the invention provides a better solution that uses detach strategy to update the gradients, explained in more detail below. Aligning instance and context representations simultaneously helps to alleviate the variances of object appearance, part deformation, object size, etc. in instance vector and illumination, scene, etc. in the context vector. dᵢ is defined as the domain label of i^{th} training image, where dᵢ=1 for the source and dᵢ=0 for the target, so the instance-context alignment loss can be further formulated as:

$${ℒ}_{I Loss} = - \frac{1}{{N}_{s}} {\sum }_{i = 1}^{{N}_{s}} {\sum }_{i , j} ( 1 - {d}_{i} ) log {P}_{( i , j )} - \frac{1}{{N}_{t}} {\sum }_{i = 1}^{{N}_{t}} {\sum }_{i , j} {d}_{i} log ( 1 - {P}_{( i , j )} ) \qquad ( 3 )$$

where:
Nₛ and Nₜ denote the numbers of source and target examples; and
P_{(i,j)} is the output probability of the instance-context domain classifier for
the j^{th} region proposal in the i^{th} image. Therefore, the total SCL objective [symbol] _{SCL} can be written as:

$${ℒ}_{S C L} = {\sum }_{k = 1}^{K} {ℒ}_{k} + {ℒ}_{I Loss} \qquad ( 4 )$$

Gradient Detach Updating—The detach strategy which prevents the flow

of gradients from the context sub-network through the detection backbone path will now be disclosed. This feature of the invention helps to obtain a more discriminative context. Further, this path carries information with diversity and, hence, suppressing gradients from this path is desirable.

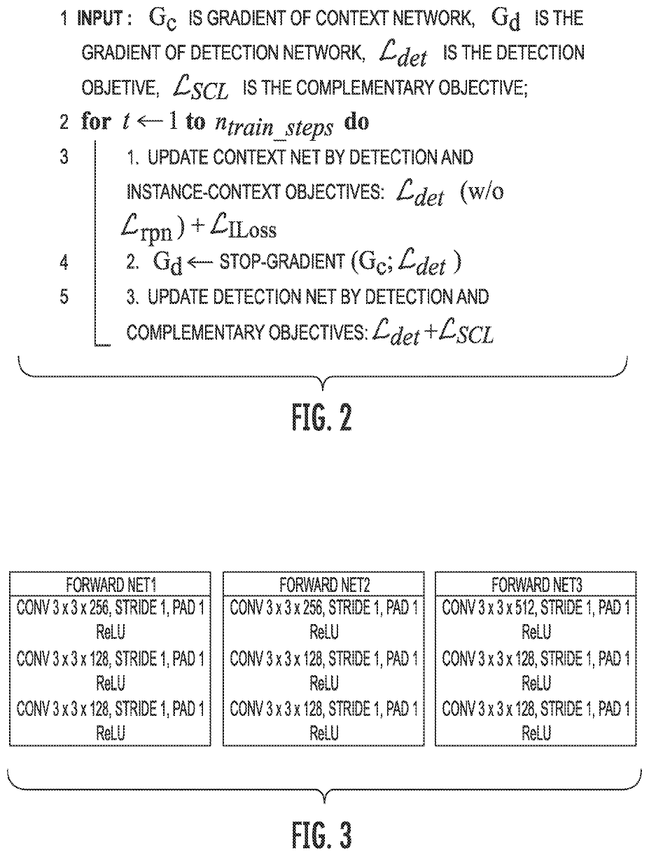

As previously mentioned, a sub-network is defined to generate the context information from early layers of the detection backbone. Intuitively, instance and context focus on perceptually different parts of an image, so the representations from either of them should also be discrepant. However, if the conventional process is used for training, the companion sub-network will be updated jointly with the detection backbone, which may lead to an indistinguishable behavior from these two parts. To this end, gradients are suppressed during backpropagation and the representation of the context sub-network is forced to be dissimilar to the detection network. This is implemented by the algorithm shown in meta-language in FIG. 2. Gradient detach is effective in helping the model to learn better context representation for domain adaptive object detection.

FIG. 3 is a table showing the details of an exemplary embodiment of the context sub-network architecture. In other embodiments, other architectures may be used.

Overall Framework—In one embodiment, the detection part is based on Faster RCNN, including the Region Proposal Network (RPN) and other modules. This is a conventional practice in many adaptive detection works. The objective of the detection loss is summarized as:

$${ℒ}_{det} = {ℒ}_{rpn} + {ℒ}_{c l s} + {ℒ}_{reg} \qquad ( 5 )$$

where:
[symbol] _{cts} is the classification loss; and
[symbol] _{reg} is the bounding-box regression loss.

To train the whole model, the overall objective function is given as:

$${min}_{ℱ , R} {max}_{D} {ℒ}_{det} ( ℱ ( Z ) , R ) - {λℒ}_{S C L} ( ℱ ( Z ) , D ) \qquad ( 6 )$$

where:
λ is the trade-off coefficient between detection loss and the complementary loss; and
R denotes the RPN and other modules in Faster RCNN.

Choosing Complementary Losses—The framework adopts three known types of losses as the complementary loss: a cross-entropy loss, a weighted least squares loss and a focal loss.

Cross-entropy (CE) loss measures the performance of a classification model whose output is a probability value. It increases as the predicted probability diverges from the actual label:

$${ℒ}_{C E} ( {p}_{c} ) = - {\sum }_{c = 1}^{C} {y}_{c} log {p}_{c} \qquad ( 7 )$$

where:
p_{c}∈[0,1] is the predicted probability observation of class c; and
y_{c} is the label of class c.

Weighted least-squares (LS) loss stabilizes the training of the domain classifier for aligning low-level features. The loss is designed to align each receptive field of features with the other domain. The least-squares loss is formulated as:

$${ℒ}_{L S} = {αℒ}_{l o c}^{( s )} + {βℒ}_{l o c}^{( t )} = \frac{α}{H W} {\sum }_{w = 1}^{W} {\sum }_{h = 1}^{H} {D ( {\hat{Θ}}^{( s )} )}_{w h}^{2} + \frac{β}{H W} {\sum }_{w = 1}^{W} {\sum }_{h = 1}^{H} {( 1 - {D ( {\hat{Θ}}^{( t )} )}_{w h} )}^{2} \qquad ( 8 )$$

where:
D( [symbol] ^{(s)})_{wh} denotes the output of the domain classifier in each location; and α and β are balance coefficients.

Focal Loss (FL) is adopted to ignore easy-to-classify examples and focus on those hard-to- classify ones during training:

$${ℒ}_{F L} ( {p}_{t} ) = - f ( {p}_{t} ) log ( {p}_{t} ) , f ( {p}_{t} ) = {( 1 - {p}_{t} )}^{γ} \qquad ( 9 )$$

where:
pₜ=p if dᵢ=1, otherwise, pₜ=1=p.

FIG. 4 shows a visualization of attention maps on source domains, showing clear images (left) and target domains, showing foggy images (right). Feature maps are used after Conv B3 in FIG. 1 for visualizing. The top row shows input images in the source and target domains. The middle row shows heatmaps from the model without gradient detach, while the bottom row shows heatmaps from models with gradient detach. The colors (red−+blue) indicate values from high to low. It can be observed that with gradient detach training, the models can learn a more discriminative representation between object areas and background (context).

Unsupervised domain adaptive object detection has been addressed through stacked complementary losses. One novel aspect of the invention is the use of gradient detach training, enabled by suppressing gradients flowing back to the detection backbone. In addition, multiple complementary losses are used for better optimization.

As would be realized by one of skill in the art, the disclosed method described herein can be implemented by a system comprising a processor and memory, storing software that, when executed by the processor, performs the functions comprising the method.

As would further be realized by one of skill in the art, many variations on implementations discussed herein which fall within the scope of the invention are possible. Moreover, it is to be understood that the features of the various embodiments described herein were not mutually exclusive and can exist in various combinations and permutations, even if such combinations or permutations were not made express herein, without departing from the spirit and scope of the invention. Accordingly, the method and apparatus disclosed herein are not to be taken as limitations on the invention but as an illustration thereof. The scope of the invention is defined by the claims which follow.

1. A method of training an object detector on source and target domains, wherein the source domain is a fully-annotated domain and the target domain is an unannotated domain, the object detector comprising:
a backbone network operating on the source domain and the target domain;
a context sub-network; and
a complementary loss module;
the context sub-network:
generating a context vector based on feature maps from the backbone network; and
suppressing backpropagation of gradients to the backbone network.

2. The method of claim 1 wherein the complementary loss module comprises:
a gradient reverse layer coupled to each layer of the backbone network;
a domain classifier coupled to each gradient reverse layer;
the complementary loss module:
generating a complementary loss for each layer of the backbone network.

3. The method of claim 2 wherein complementary loss for each layer of the backbone network is based on feature maps from the source domain, the target domain and the domain classifier.

4. The method of claim 3 further comprising:
applying the complementary loss for each layer of the backbone network.

5. The method of claim 4 further comprising a detection network coupled to the backbone network, the detection network:
generating a plurality of instance vectors.

6. The object detection model of claim 5, the complementary loss module:
generating an instance-context alignment loss.

7. The method of claim 6 further comprising:
concatenating each of the plurality of instance vectors with the context vector; and
generating the instance-context alignment loss based on the concatenated instance-context vectors.

8. The method of claim 7, the complementary loss module:
generating a stacked complimentary loss as a sum of the complementary losses from each layer of the backbone network added to the instance-context alignment loss.

9. The method of claim 8 further comprising:
updating the detection network in accordance with an objective based on a detection loss and the stacked complementary loss.

10. The method of claim 9 wherein the detection network is based on Faster RCNN, including a region proposed network.

11. The method of claim 9 wherein the detection loss is generated as a sum of a loss from the region proposed network, a classification loss and a bounding box regression loss.

12. The method of claim 2 wherein the complementary loss for each layer of the backbone network is a cross-entropy loss, a weighted least-squares loss or a focal loss.

13. A system comprising:
a processor; and
memory, storing software that, when executed by the processor, performs the method of claim 9.
